(19) United States
(12) Patent Application Publication
(10) Pub. No.: US 2005/0088415 A1
(43) Pub. Date: Apr. 28, 2005

(54) Character input method and character input device

(76) Inventor: Wai Sze To, Kowloon (CN)

Correspondence Address: BURNS DOANE SWECKER & MATHIS L L P, POST OFFICE BOX 1404, ALEXANDRIA, VA, 22313-1404, US

(21) Appl. No.: 10/692,859

(22) Filed: Oct. 27, 2003

(51) Int. Cl. G09G 5/00

(52) U.S. Cl. 345/168

(57) ABSTRACT

A method of inputting characters into a device having a data processor, a memory and a number of keys is disclosed as including the steps of (a) providing, in the memory, a table of key-actuating sequences, each of the sequences corresponding to a respective character; (b) actuating the keys; (c) detecting the sequence of actuation of the keys; (d) matching the sequence of actuation of the keys with key-actuating sequences in the table of key-actuating sequences; and (d) retrieving the character whose corresponding key-actuating sequence matches the sequence of actuation of the keys, and the lines joining consecutive keys of a key-actuating sequence resemble the shape of the corresponding character. A character input device having a data processor, a memory and a number of keys is disclosed in which the memory includes a table of key-actuating sequences, each of the sequences corresponding to a respective character; the data processor being adapted to detect the sequence of actuation of the keys, to match the sequence of actuation of the keys with key-actuating sequences in the table of key-actuating sequences, and to retrieve the character whose corresponding key-actuating sequence matches the sequence of actuation of the keys, and the lines joining consecutive keys of a key-actuating sequence resemble the shape of the corresponding character.

### FIELD OF THE INVENTION

This invention relates to a method of inputting characters into such devices as cellular phones, personal digital assistants (PDAs), remote controllers, game pads, etc., and in particular a method whereby characters may be inputted into such devices by operating a number of keys of the devices.

### DESCRIPTION OF THE RELATED ART

Nowadays, input of characters into mobile devices is essential for communications. Several character-input methods are being used for overcoming the size and space limitation of such devices.

A first method utilizes character recognition technology for recognizing hand-written characters. A second method utilizes part of the display screen as a soft keyboard or digitizer. These two methods are mainly used in PDAs equipped with touch-screen displays. A third method makes use of the numeral keypad. A number of alphabets are mapped to each of the numeral keys. This method is used mostly in cellular phones.

When the first two methods mentioned above are employed in conventional PDAs, a user has to use both of his/her hands, one to hold the PDA and one to hold the stylus pen to write on the screen or tap on the soft keyboard displayed in the PDA. Part of the screen area is thus used for displaying the soft keyboard. Although the current character recognition technology is very advanced, it is still not able to recognize all hand-written characters with 100% accuracy. That means selection operations may still be required after writing of the characters.

The third method mentioned above, i.e. the one employing numeral keypad, is inconvenient to use, as each key is associated with three or more alphabets, thus resulting in confusion and difficulty in learning and memorizing. It is even more difficult when used for inputting non-alphabet symbols.

Moreover, none of the above methods can perform “touch-typing” or so called “blind-typing” operations, in which a user may be so trained that he/she can type all the characters into the electronic device without having to look at the keyboard or the visual display, e.g. screen.

Attempts have also been made to use one or more keys/joysticks that have different directional properties to represent different characters with one particular key.

In order to represent all letters of the alphabets (a-z), numerals (0-9) and other symbols, three associated input devices have been proposed. One of them employs rocker switches that can be depressed to different directions and a group of rocker switches work together to represent all characters. For example, US Patent Document No. US-A-2002/0140679 describes a keyboard in which each of a number of rocker switches can be depressed to the left, to the right or centrally to input three different letters. It is therefore necessary to use nine rocker switches to represent all twenty-six letters of the alphabet. International Patent Document No. WO-A-02/063455 describes an alphanumeric keyboard in which each number key is formed as a joystick that can also be moved upward, downward, leftward and rightward to input four letters. With this arrangement, it is necessary to employ ten joysticks in order to represent all twenty-six letters of the alphabet and the ten numerals. UK Patent Document No. GB-2381854-A describes the use of four joysticks, each being movable in nine directions, thus capable of representing a total of thirty-six characters.

Another method employs only one directional key/joystick, but which has many directions and states, or in which a number of characters are represented by one state. US Patent Document No. US-2003/0001821-A1 describes a device with a joystick movable in four directions and depressible to switch between a first mode and a second mode of operation. The are therefore eight possible states, each representing three to four characters. Japanese Patent Document No. JP2002-312118A describes a device with a joystick that can be move in eight directions, with two steps in each direction. The device can also be switched among six modes. It thus has a total of ninety-six possible states.

The above attempts are made mainly to reduce the number of keys required for inputting characters by employing multiple states on a key/joystick. However, they work in a digitized way that is even more confusing and difficult for human to memorize and learn. If users cannot remember all the states thoroughly, they are actually doing the character selection rather than typing.

A further similar attempt is to use a joystick to draw the characters. Patent Document No. JP2002-259907A discloses a device with a detector for detecting the movement of an operation rod of the joystick which is transferred from its center position to a prescribed range and again returns to its Center. A recognition unit identifies the character and symbol of the line printing, based on the detection result. Since the movement of the joystick is not as precise as a touch screen or handwriting pad, the outcome is generally worse than the traditional handwriting system. Character selection needs to be carried out after writing of each character, thus slowing down the character input process.

Owing to the improvement of technology, mobile devices are becoming more and more compact. The absence of an easy to use, small footprints, touch-typing enabled and single-hand operable character input method and interface that can be implemented in such compact mobile devices is an obstacle to the development and design of such devices.

It is thus an object of the present invention to provide a character input method in which the aforesaid shortcomings are mitigated, or at least to provide a useful alternative to the public.

### SUMMARY OF THE INVENTION

According to a first aspect of the present invention, there is provided a method of inputting characters into an apparatus having a data processor, a memory and a plurality of keys, including the steps of (a) providing, in said memory, a table of key-actuating sequences, each said sequence corresponding to a respective character; (b) actuating said keys; (c) detecting the sequence of actuation of said keys; (d) matching the sequence of actuation of said keys with key-actuating sequences in said table of key-actuating sequences; and (e) retrieving the character whose corresponding key-actuating sequence matches the sequence of actuation of said keys, wherein the lines joining consecutive keys of a key-actuating sequence resemble the shape of the corresponding character.

According to a second aspect of the present invention, there is provided a character input device having a data processor, a memory and a plurality of keys, wherein said memory includes a table of key-actuating sequences, each said sequence corresponding to a respective character; said data processor is adapted to detect the sequence of actuation of said keys, to match the sequence of actuation of said keys with key-actuating sequences in said table of key-actuating sequences, and to retrieve the character whose corresponding key-actuating sequence matches the sequence of actuation of said keys, wherein the lines joining consecutive keys of a key-actuating sequence resemble the shape of the corresponding character.

### BRIEF DESCRIPTION OF THE DRAWINGS

FIG. 1A shows a device having a five-button keypad capable of implementing a character input method according to the present invention;

FIG. 1B shows a device having a five-button keypad with the fifth button arranged beside the four buttons, capable of implementing a character input method according to the present invention;

FIG. 1C shows a device utilizing five buttons of an existing numeral keypad to input characters, according to the present invention;

FIG. 1D shows a device having a joystick at a side of the device;

FIG. 1E shows a device having a five-button keypad and with a mode change and clear button;

FIGS. 2A to 2E show the theory of the present invention on how to write a letter “a” by using the five buttons;

FIG. 3A is a flow chart showing the steps whereby inputted key sequences are translated into desired characters;

FIG. 3B is a flow chart showing the steps of operation of a device according to the present invention, with a mode change and clear button;

FIG. 4 is a table showing the construction of the letters of the alphabets from “a” to “z”;

FIG. 5 is table showing the construction of numerals from “0” to “9”;

FIG. 6 is a table showing the construction of various symbols;

FIG. 7 is a table showing the construction of various functional keys;

FIG. 8 is a table showing the construction of some other examples of European characters and special symbols;

FIG. 9 is a table showing the construction of Japanese characters by using phonics alphabets; and

FIG. 10 is a table showing the implementation of ChangJie Chinese input method by a method according to the present invention.

### DETAILED DESCRIPTION OF THE PREFERRED EMBODIMENTS

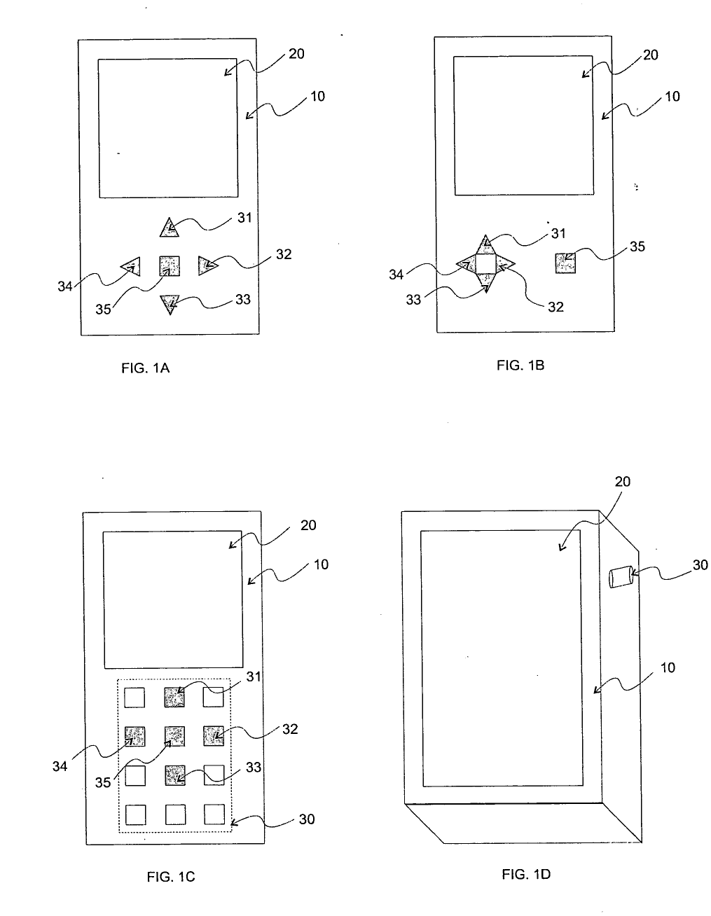

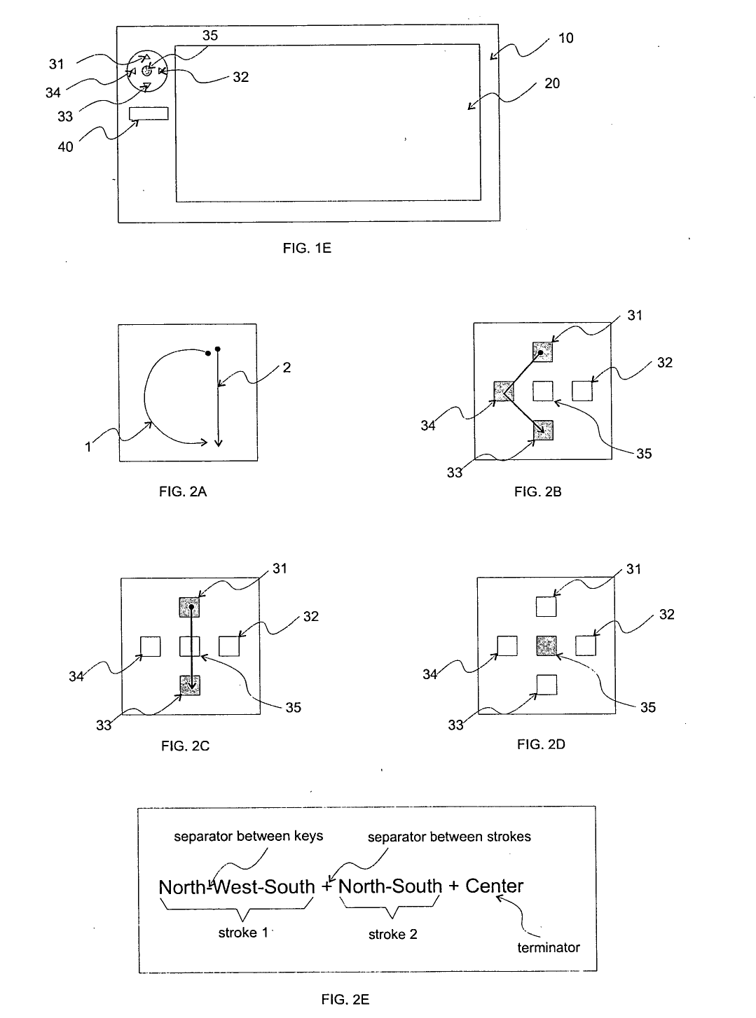

Referring now to FIG. 1A, such shows a first embodiment of an electronic device 10 including a body 12, a display 20, and a five-button keypad, in which a character input method according to the present invention is implemented. The electronic device 10 is provided with a data processor and a memory, e.g. RAM. The keypad includes a “North” button 31, an “East” button 32, a “South” button 33, a “West” button 34, and a “Center” button 35 positioned centrally among the other four buttons 31, 32, 33, 34. It should be understood that, in the present invention, “characters” include numerals, letters, radicals, symbols or the like, which can be inputted, processed and displayed by an electronic device, such as PDAs, mobile phones and the like.

In a second embodiment, and as shown in FIG. 1B, the “Center” button 35 is arranged beside the other four buttons 31, 32, 33, 34.

In a third embodiment as shown in FIG. 1C, the five buttons 31, 32, 33, 34, 35 are realized by utilizing the exiting numeral keys “2”, “4”, “6”, “8” and “5” of a numeral keypad.

In a fourth embodiment, and as shown in FIG. 1D, a joystick 30 is arranged on a side of the device 10.

In a fifth embodiment, and as shown in FIG. 1E, in addition to the five buttons, there is provided an optional mode change and clear button 40.

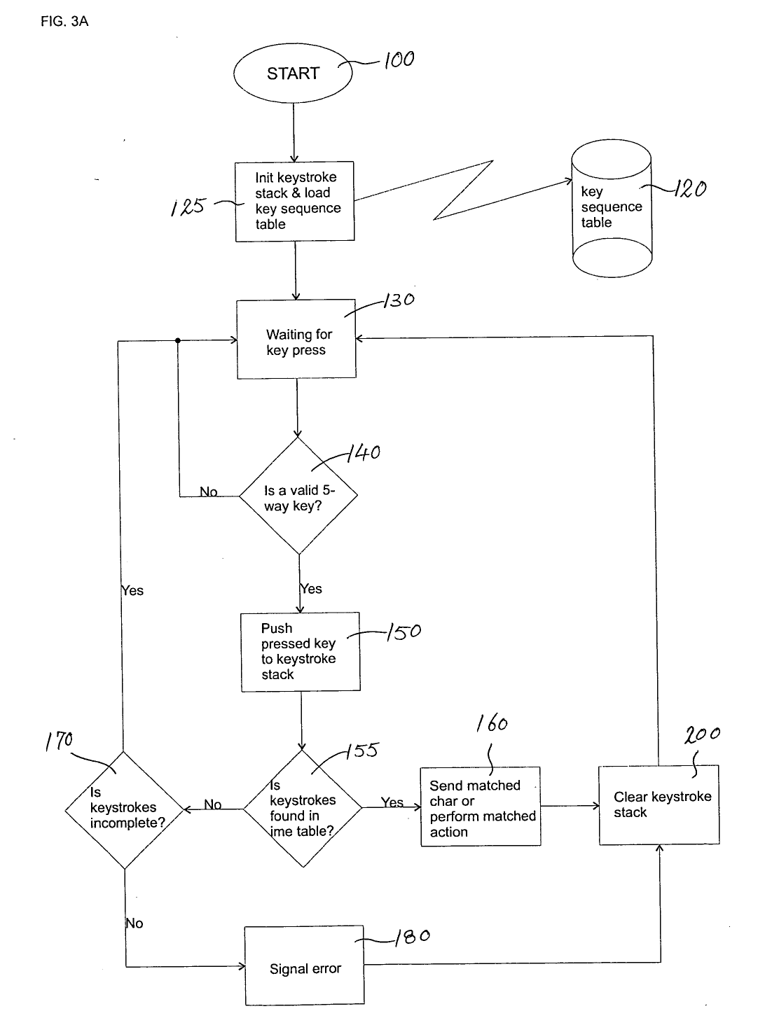

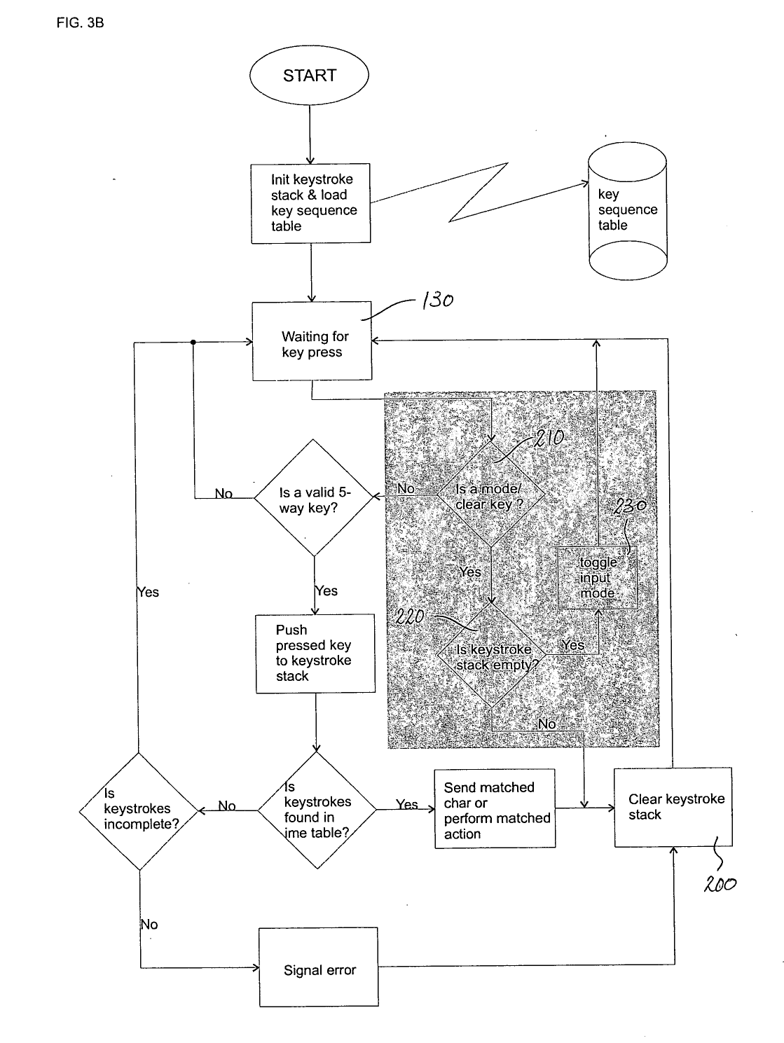

Referring now to FIG. 2A, it can be seen that a lower-case letter “a” consists of two strokes, namely a semi-circular stroke 1 and a vertical downward stroke 2. Referring now to FIG. 2B, according to a method of the present invention, the first stroke of the letter “a” is represented and entered into the device by pressing the “North” button 31, the “West” button 34, and then the “South” button 33 in sequence. The second stroke of the letter “a” is represented and entered into the device by pressing the “North” button 31 and then the “South” button 33, as shown in FIG. 2C. Finally, referring now to FIG. 2D, the “Center” button 35 is pressed to confirm the completion of input of a character.

The general notation of sequential pressing of several buttons for inputting one stroke of a character is “Button 1-Button 2- . . . -Button N”, and the strokes are linked with each other by “+”, i.e. “Stroke 1+Stroke 2+ . . . +Stroke N”. Therefore the notation of the letter “a” is in the form “North-West-South+North-South+Center”.

FIG. 3A is a flow chart showing how the key sequences are processed by a device in which a method according to the present invention is implemented. A predefined key sequence table 120 is loaded (Step 125) when the present invention of input is selected (Step 100). The key sequence table 120 contains a list of the possible key sequences and their respective corresponding character, letter of the alphabet, numeral, symbol or the like. Then key pressing event is awaited (Step 130). When a key is pressed, it is validated (Step 140). If it is a valid key, the pressed key is appended to a key sequence buffer (Step 150); otherwise, another key press action is awaited (Step 130). After that, key sequences buffer is checked against the pre-loaded table 120 (Step 155). If a character is founded in the table 120, the matched character will be retrieved and sent for display or some other function is performed (Step 160). Otherwise, another check is preformed to verify the key sequence buffer to see whether it matches with the beginning of one of the pre-defined sequences in the table (Step 170). If it is matched, another key press action is awaited (Step 130). Otherwise, an error signal is raised (Step 180). After a matched character or function is performed (Step 160), e.g. the matched character is displayed in a visual display unit, or if an error signal is raised (Step 180), the key sequence buffer is cleared (Step 200), then another key press event is awaited (Step 130).

As to FIG. 3B, such is a flow chart showing the operation of a device according to a further embodiment of the present invention, in which a mode change and clear key (“mode/clear key”) is provided. The manner of operation of such a device is similar to that described above and shown in the flow chart of FIG. 3A. The main difference is that, when a key is pressed (Step 130), the device will first check whether the pressed key is the mode/clear key (Step 210). If not, it will proceed to check whether such is a valid 5-way key (Step 14). If, however, the pressed key is the mode/clear key, the device will check whether the keystroke stack is empty (Step 220). If so, the pressing of the key will be interpreted as a command for change of mode, such that a toggle of input mode will be executed (Step 230), setting in a different input mode for subsequent operation. If, on the other hand, the keystroke stack is not empty, the keystroke stack will then be emptied (Step 200), after which the device will again await key pressing (Step 130).

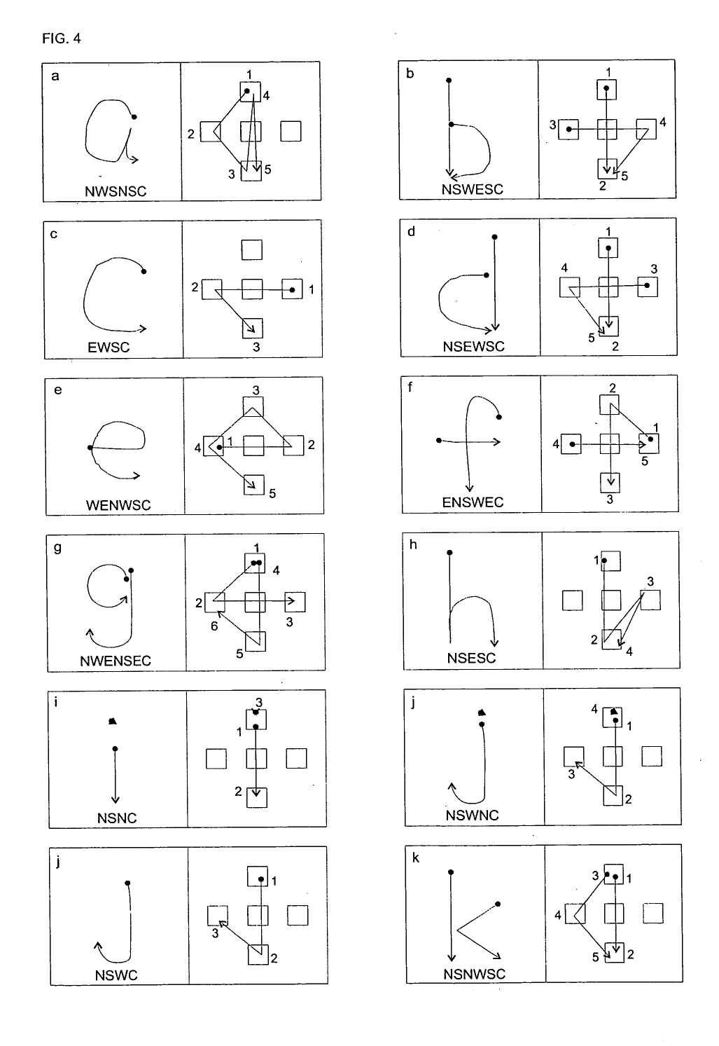

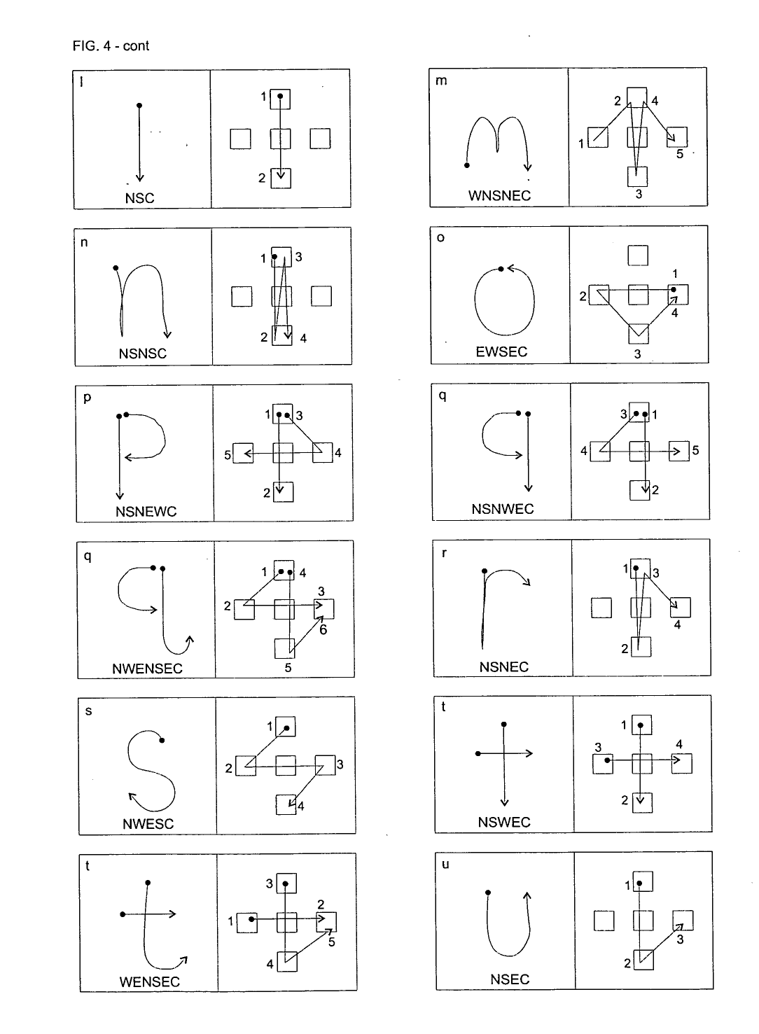

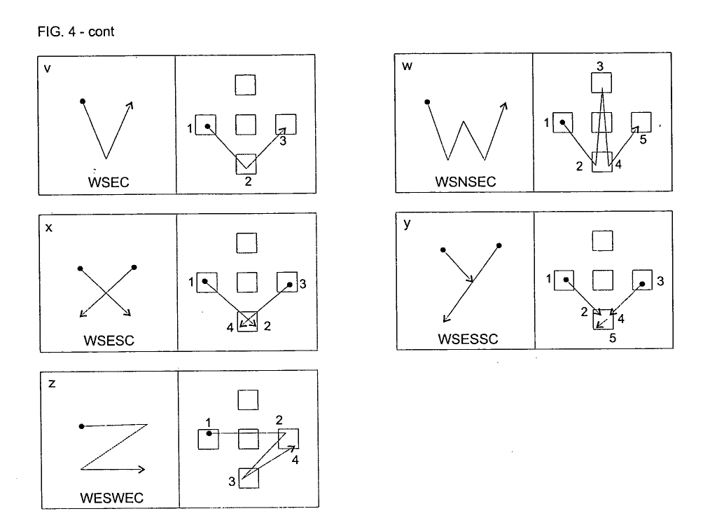

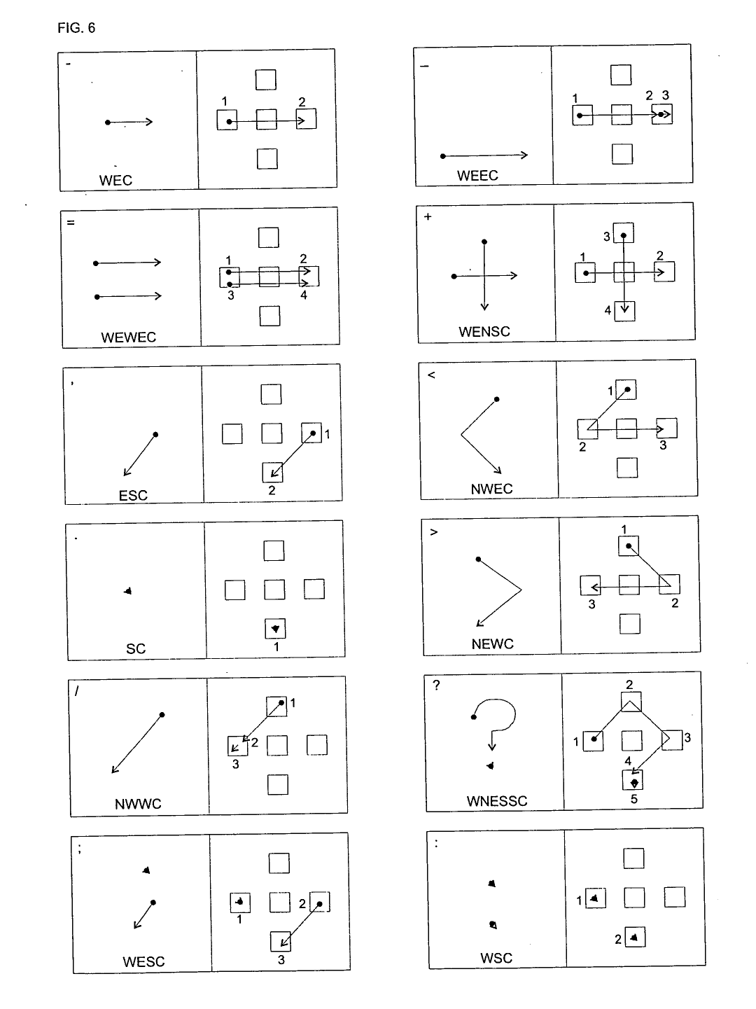

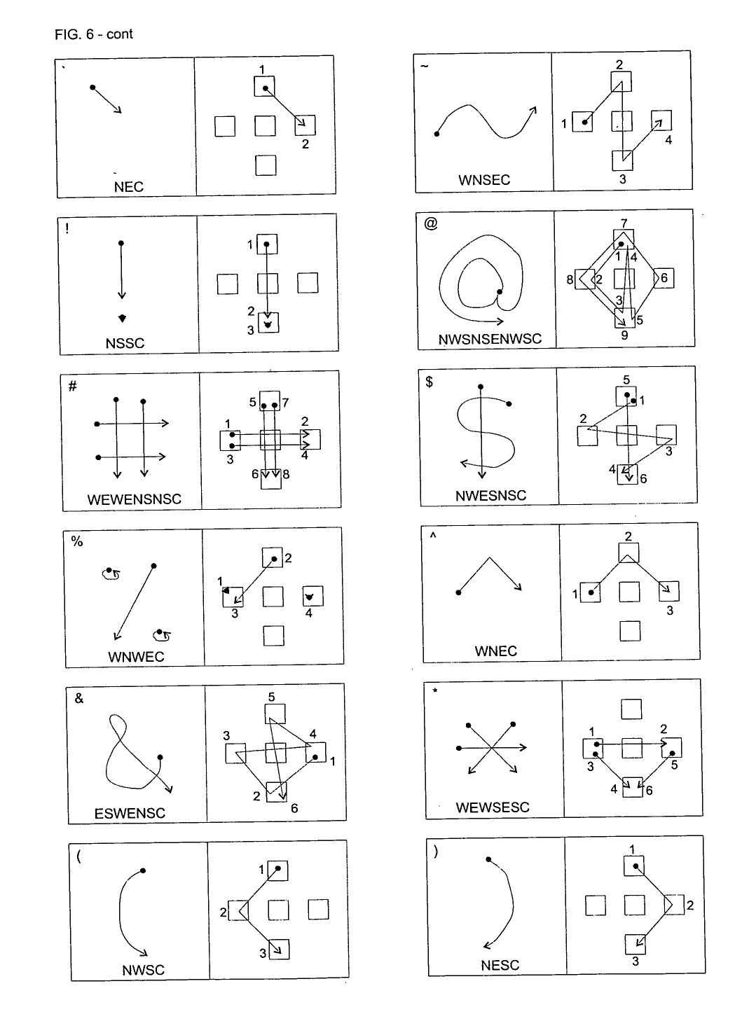

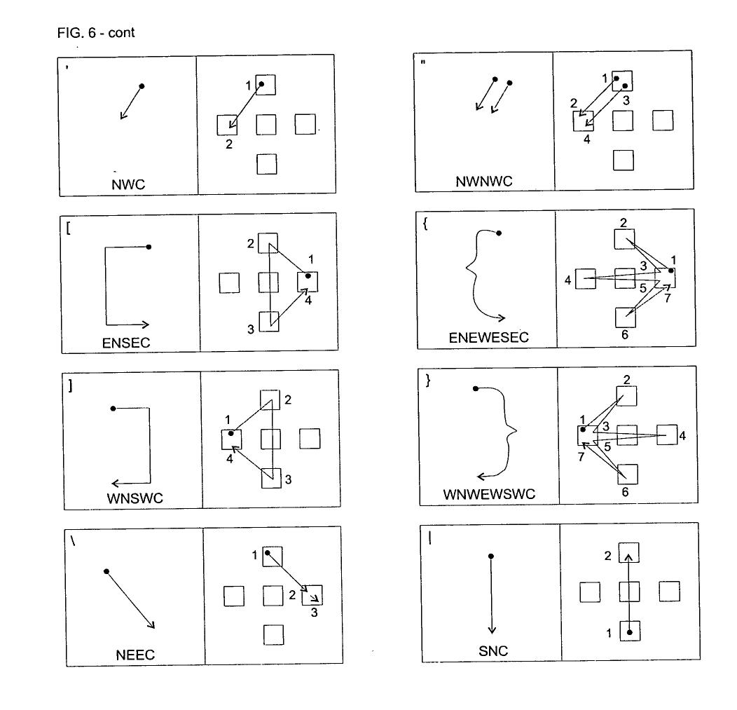

Referring now to FIGS. 4, 5, 6 and 7, such show key sequences of inputting lower case letters of the alphabet, Arabic numerals, symbols, function keys and editing keys in a single mode to avoid mode switching.

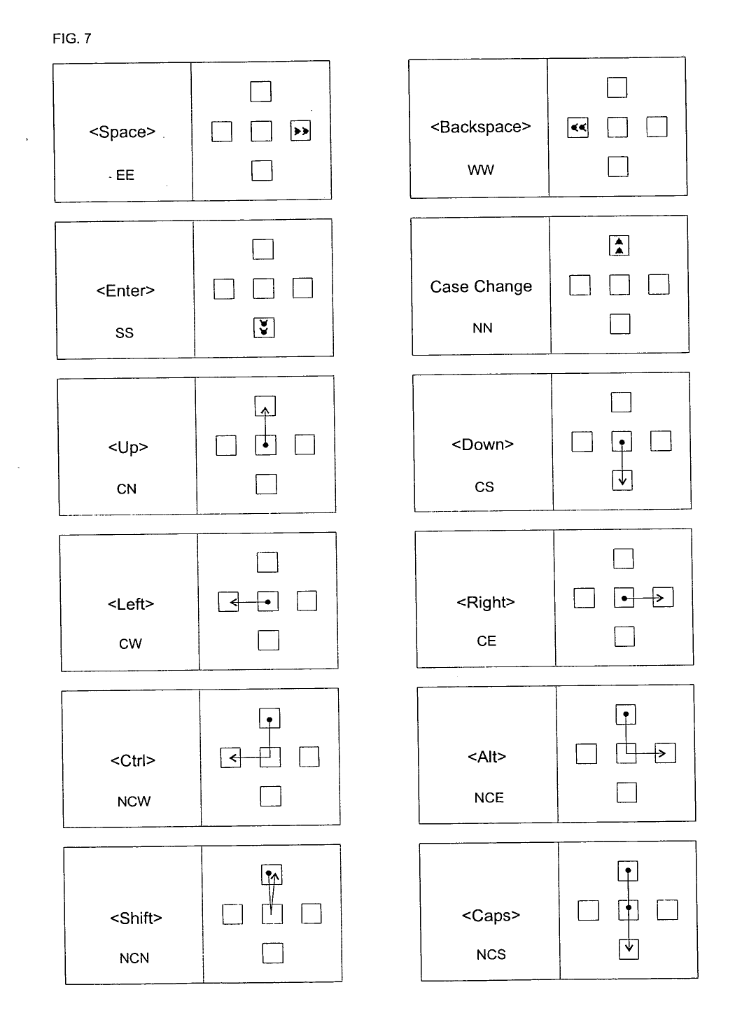

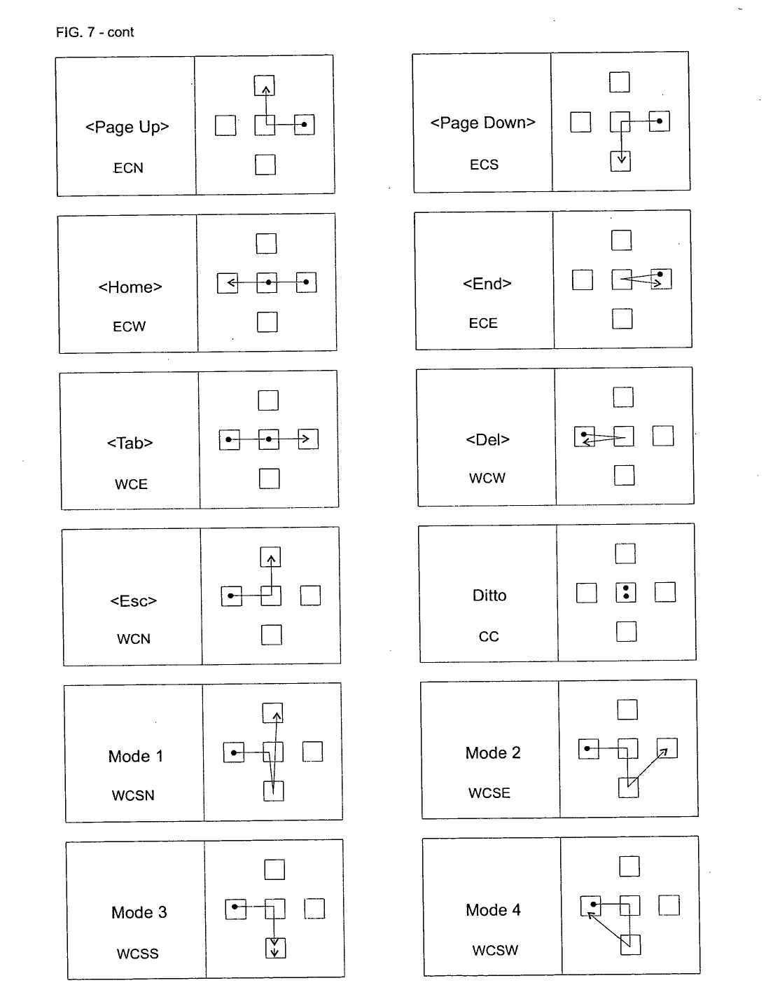

Referring now to FIG. 4, only lower case letters of the alphabet are defined. Upper case letters of the alphabet are inputted by using the case change, shift or the caps function keys which are defined in FIG. 7.

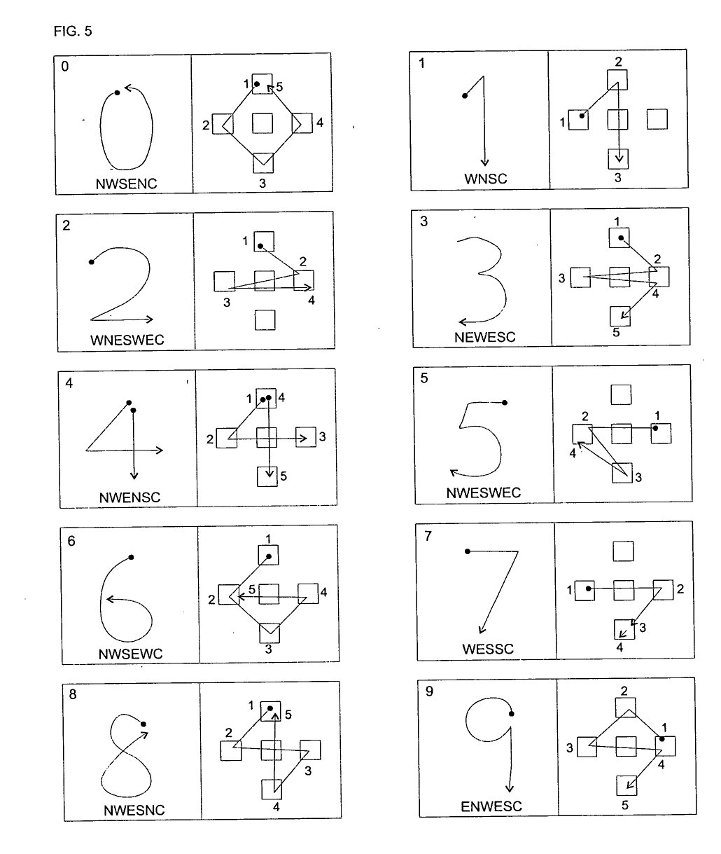

Referring now to FIGS. 4 and 5, the letter “o” and the numeral “0” are very similar in appearance when hand-written. To distinguish between them, the letter “o” is represented by the button sequence “East-West-South-East”; whereas the numeral “0” is represented by the button sequence “North-West-South-East-North”. There are other similar examples: the symbol “(” and the letter “c”, the letter “1”, the numeral digit “1” and the symbol “I”. These minor compromises can avoid duplications of the same key sequence for inputting different characters, numerals or symbols. As a result, input of letters of the alphabet, Arabic numerals and symbols can be catered for by the same input mode, thus eliminating the mode switching burden of character input.

Referring now to FIG. 4-“y” is represented by the sequence “West-South+East-South-South”. The second “South” of the second stroke further extends the length of “East-South”. There are more examples in the present invention, e.g. “7”, “_”, “/”, and “\”.

The present invention is not limited to methods of inputting letters of the alphabet, Arabic numerals and symbols. Input of characters of other languages can also be implemented by defining the key sequences according to the same methodology or mapping into letters of the alphabet. In order to represent other character sets and avoid key sequence duplication, mode switching functional key sequences are defined and as shown in FIG. 7, so that there are four possible modes, namely Mode 1, Mode 2, Mode 3 and Mode 4. In the device as shown in FIG. 1E, a mode switching button is provided for easy switching of modes.

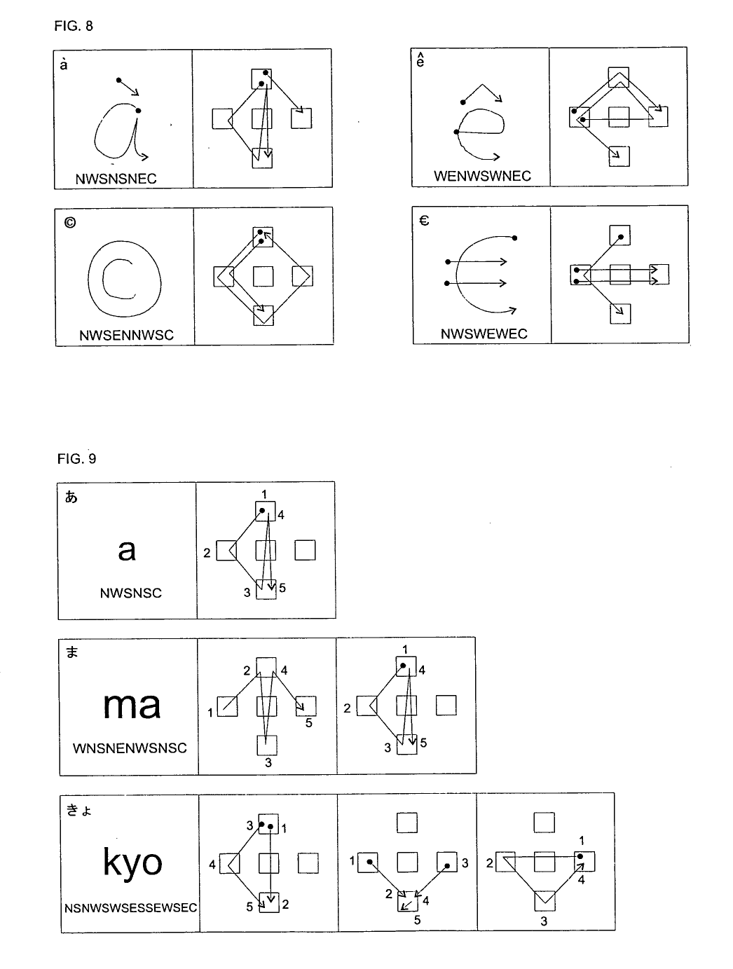

Referring now to FIG. 8, such shows some examples of European characters and other special symbols defined by using the same methodology.

Japanese alphabets are represented by phonics/Pinyin characters. Thus, as shown in FIG. 9, the “Center” key between the two letters is eliminated. Take “ma” ( [symbol] ) as an example, “m” is represented by “West-North-South-North-East+Center” and “a” is represented by “North-West-South+North-South+Center”, the button sequences for “m” and “a” are joined together and the “Center” between them is eliminated. Thus, “ma” is represented by “West-North-South-North-East+North-West-South+North-South+Center”. Then, by pressing a case change function key sequences: “North-North”, the inputted character can be changed from Hiragana ( [symbol] ) to Katakana ( [symbol] ).

Most of the Phonics/Pinyin input methods of different languages are easily implemented by mapping their phonics characters to Latin charters, as they already exist and utilize the normal QWERTY keyboard.

However, other input methods not using phonics/Pinyin, especially methods for inputting Chinese characters, are not easy to use if such input methods are mapped into letters of the alphabets or Arabic numerals, because the user has to do a “double translation” and it is not intuitive enough.

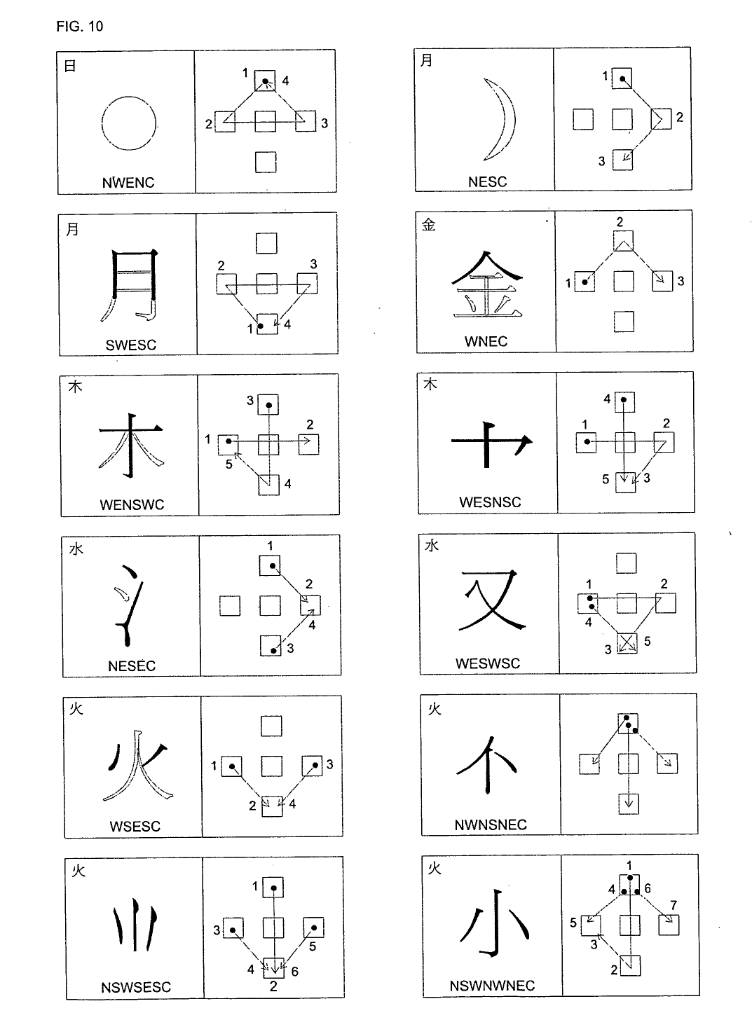

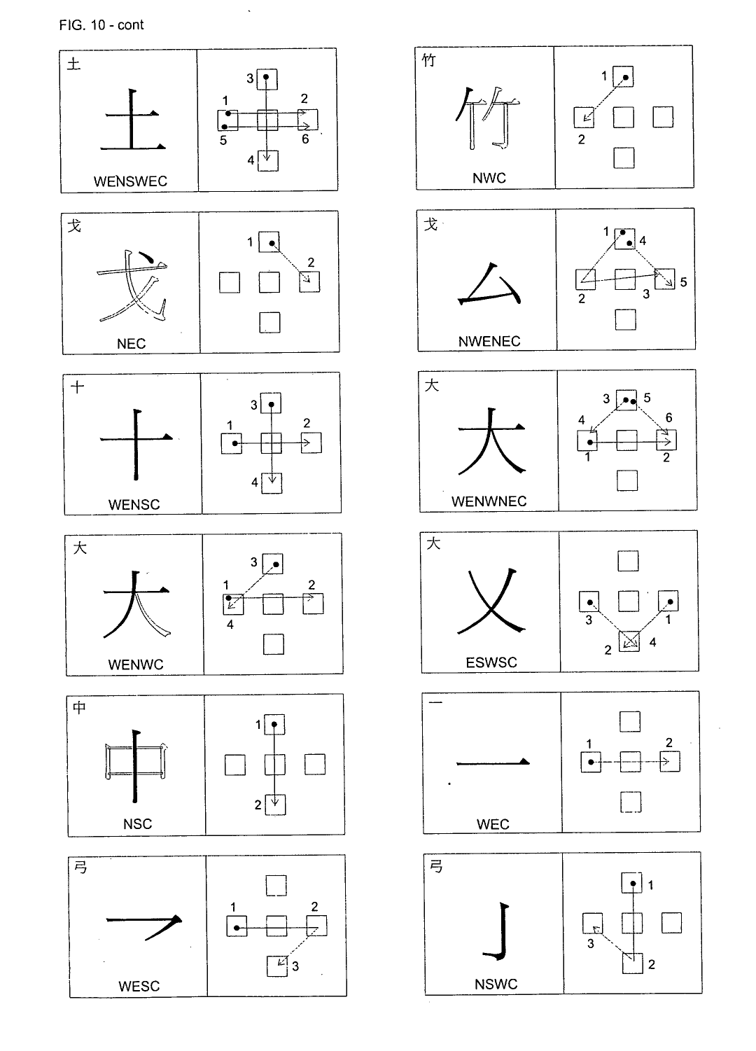

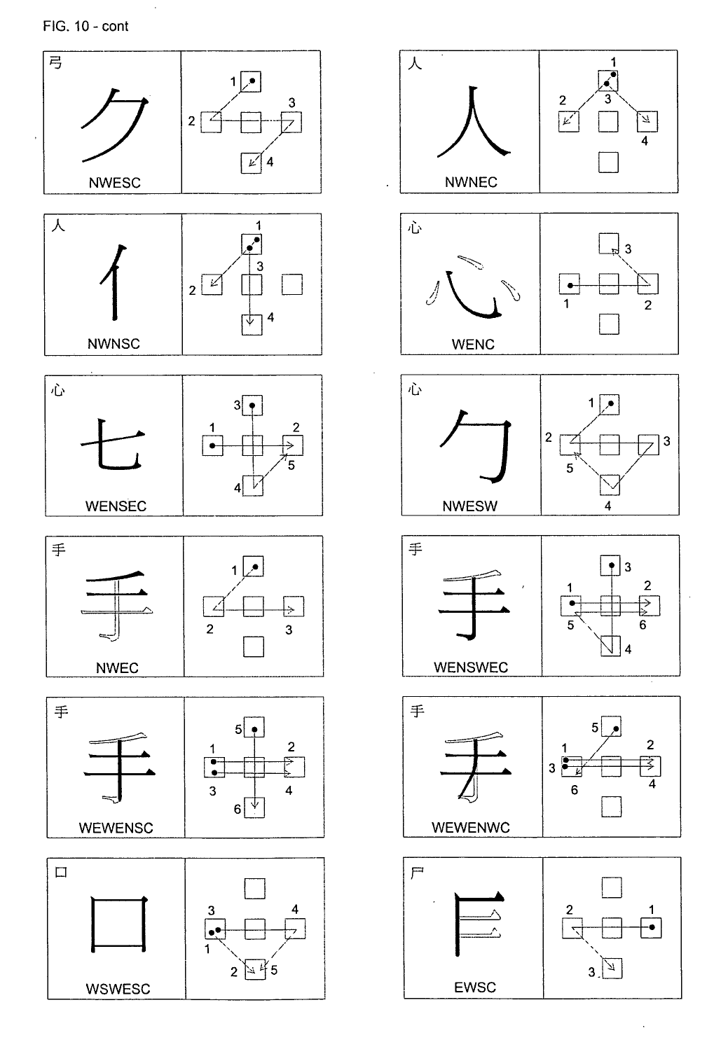

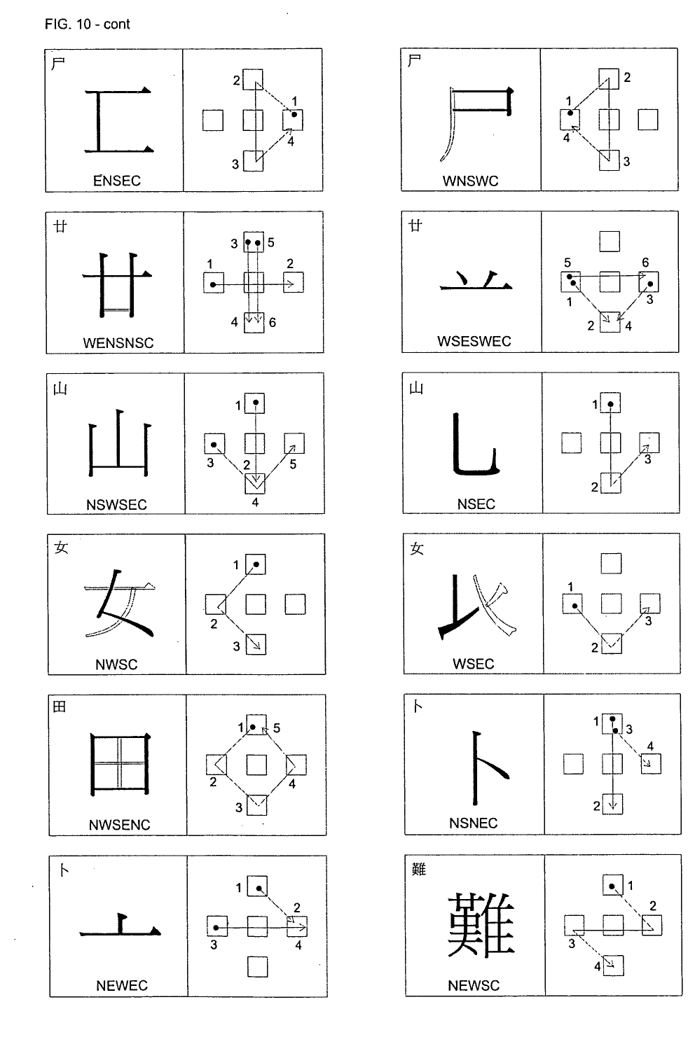

To overcome such problems, the same methodology of the present invention can be applied to such input methods. Take ChangJie Chinese input method as an example. Referring now to FIG. 10, the basic radicals of ChangJie Chinese input method are defined according its hand writing strokes. The end of the radical input is still terminated by pressing the “Center” button, and the end of a Chinese word is terminated by pressing the <Space> key, i.e. “East-East” as in the existing way of such input method. Take the Chinese word “ [symbol] ” as an example, the ChangJie input is “ [symbol] ” and “ [symbol] ”, then pressing the <Space> button. According to the present invention, it can be represented by “North-West-East-North+Center+North-East-South+Center+East-East”.

Particular implementations and embodiments of the invention have been described and that many modifications and developments may be made in other embodiments using equivalent means without deviating from the characteristics of the invention.

1. A method of inputting characters into a device having a data processor, a memory and a plurality of keys, including the steps of:
a. providing, in said memory, a table of key-actuating sequences, each said sequence corresponding to a respective character;
b. actuating said keys;
c. detecting the sequence of actuation of said keys;
d. matching the sequence of actuation of said keys with key-actuating sequences in said table of key-actuating sequences; and
e. retrieving the character whose corresponding key-actuating sequence matches the sequence of actuation of said keys,
wherein the lines joining consecutive keys of a key-actuating sequence resemble the shape of the corresponding character.

2. A method according to claim 1 wherein the direction and path of movement among said consecutive keys of a key-actuating sequence resemble the stroke sequences of the corresponding character.

3. A method according to claim 1 further including a step of pressing one of said keys to indicate completion of input of a character.

4. A method according to claim 1 further including a step of pressing one of said keys to switch the mode of operation of said device.

5. A method according to claim 1 further including a step of pressing one of said keys to clear data in a key sequence buffer.

6. A character input device having a data processor, a memory and a plurality of keys, wherein said memory includes a table of key-actuating sequences, each said sequence corresponding to a respective character; said data processor is adapted to detect the sequence of actuation of said keys, to match the sequence of actuation of said keys with key-actuating sequences in said table of key-actuating sequences, and to retrieve the character whose corresponding key-actuating sequence matches the sequence of actuation of said keys, wherein the lines joining consecutive keys of a key-actuating sequence resemble the shape of the corresponding character.

7. A device according to claim 6 including up to five keys for inputting characters into said device.

8. A device according to claim 7 wherein four of said five keys are respectively positioned at a north, east, south and west position.

9. A device according to claim 8 wherein a fifth of said five keys is operable to indicate the completion of input of a character.

10. A device according to claim 9 wherein said fifth key is positioned among the other four keys.

11. A device according to claim 6 wherein one of said keys is acutable to change the mode of operation of said device.

12. A device according to claim 6 wherein one of said keys is actuable to clear the data in a key sequence buffer.
